(19) United States
(12) Patent Application Publication
(10) Pub. No.: US 2009/0328203 A1
(43) Pub. Date: Dec. 31, 2009

(54) PARAMETRIC BASED CONDITIONAL ACCESS CODES FOR ACCESS CONTROL APPLICATIONS

(75) Inventor: Kenneth John Haas, Whitewater, WI (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL INC., Morristown, NJ (US)

(21) Appl. No.: 12/122,957

(22) Filed: May 19, 2008

(51) Int. Cl. H04L 9/32; G06F 21/00

(52) U.S. Cl. 726/20

(57) ABSTRACT

A system and method is disclosed for providing conditional access control using a parametric-based conditional access code. The parametric-based access code is generated by a access grantor, such as a homeowner, parent, employer, rental company, etc., from a set of parameter values associated with an access control device. Such parameters can include date and time, location, purchase amount, type of purchase, etc. Once a parametric-based access code is generated, it can be used by the grantee, i.e., the person seeking access, at the appropriate access control device. The access control device extracts the conditional parameter values and compares them to current parameter values of the access control device. Access is granted only when the conditional parameter values match the current parameter values.

### I. FIELD OF THE INVENTION

The present invention relates generally to security systems. More specifically, the present invention relates to providing parametric-based conditional access codes in access control systems.

### II. BACKGROUND OF THE DISCLOSURE

Many simple access control applications only require an individual to use an alphanumeric or numeric access code to gain access to a controlled area or controlled privilege. For these simple access control applications, the access code is unique to the controlled area or controlled privilege—and not the individual entering the access code.

Hereinafter, the term “grantee” is used in reference to individuals seeking access to a controlled area or privilege. Likewise, the term “grantor” refers to the entity granting access to a controlled area or privilege. In most situations the grantor will be an employer or owner of a property in which the controlled area is located.

Typically, the access code is directly related to the serial number of the access control device. Examples of these simple access codes include access codes for keyless lock keypads (controlled area), and personal identification numbers (PIN) for debit or credit cards (controlled privilege).

There are situations in which a grantor would like to give a grantee an access code that would limit the grantee access based on defined parameters beyond just a serial number of the access control device. The access code would only be valid during a period in which the parameters known by the access control device and used to create the access code are valid. This would give the grantor finer control over access to a controlled area or privilege, since the grantee would only be able to use the assigned access code under specific parameters.

### III. SUMMARY OF THE DISCLOSURE

The grantor does not need to reprogram the access control device to change the conditional access code. The conditional access code changes with the parameters in the access control device. The grantor can calculate a conditional access code by knowing the decoding formula and the parameter values associated with the access control device.

Any parameter known by the access control device at the time of the access request may be used by 1) the access control device to determine the validity of the conditional access code and 2) the grantor to generate the conditional access code. The grantor generates the conditional access code based on the relevant parameters, which define the conditional access requirements.

The encryption formula used to create the conditional access code is known by both the grantor and the access control device. The grantor uses the formula to generate the conditional access code. The access control device uses the inverse formula to decode the conditional access code into the parameters used to generate it.

The access control device compares the decoded parameters from the conditional access code with the current parameters of the access control device. Access is granted if the decoded parameters match the current parameters.

An embodiment of the present invention includes a method for providing conditional access to secured areas and privileges. The method generates a unique access code based on conditional parameters; the unique access code is entered into an access control device; the unique access code is checked by the access control device against parameters of the access control device; and access is granted by the access control device when the unique access code corresponds to the parameters.

Another embodiment of the present invention is an access control device having an input unit for accepting a conditional access code; a decrypting unit for decrypting the conditional access code; an extracting unit for extracting at least one conditional parameter for granting access contained within the conditional access code; at least one parameter maintaining unit for maintaining a parameter of the access control device; and a processor for comparing the extracted at least one conditional parameter against the maintained parameter of the access control device and determining whether to grant access based on the comparison.

Another embodiment of the present invention is a computer readable medium embodying a set of computer executable instructions for controlling a processor to perform a method of parametric-based conditional access code generation. The method includes the steps of providing a list of conditional access parameters associated with parameters of an access control device; selecting values for each of the conditional access parameters; and generating a unique access code corresponding to the selected values; encrypting the unique access code; and outputting the encrypted access code.

Another embodiment of the present invention is a computer readable medium embodying a set of computer executable instructions for controlling a processor of an access control device to perform a method of access control based on a parametric-based conditional access code. The method includes the steps of receiving a parametric-based conditional access code from a grantee; decrypting said conditional access code; extracting conditional parameter values from said decrypted conditional access code; retrieving current parameter values of said access control device; comparing said conditional parameter values against said current parameter values; and determining whether or not to grant access to said grantee based on said comparison.

### IV. BRIEF DESCRIPTION OF THE DRAWINGS

These and other features, aspects, and advantages of the present invention will become better understood with regard to the following description, appended claims, and accompanying drawings wherein:

FIG. 1 illustrates a flow diagram of a process for performing an embodiment of the present invention;

FIG. 2 illustrates a block representation of an embodiment of the present invention; and

FIG. 3 illustrates a block representation of another embodiment of the present invention.

### V. DETAILED DESCRIPTION OF DISCLOSURE

A parametric-based access code for use with access control devices in accordance with the present invention is generated using a computing device, such as a computer or personal digital assistant (PDA). The computing device provides an interface allowing a user to indicate specific parameters for which access is to be granted by an access control device.

The parameters are dependent on the particular access control device targeted. However, standard parameters include time and date of access, and location of access. In the case of a credit card access, additional parameters can include credit limit. In general, any parameter known by the access control device at the time of the access request may be used as a condition for access by the access control device and used by the grantor to generate the conditional access code.

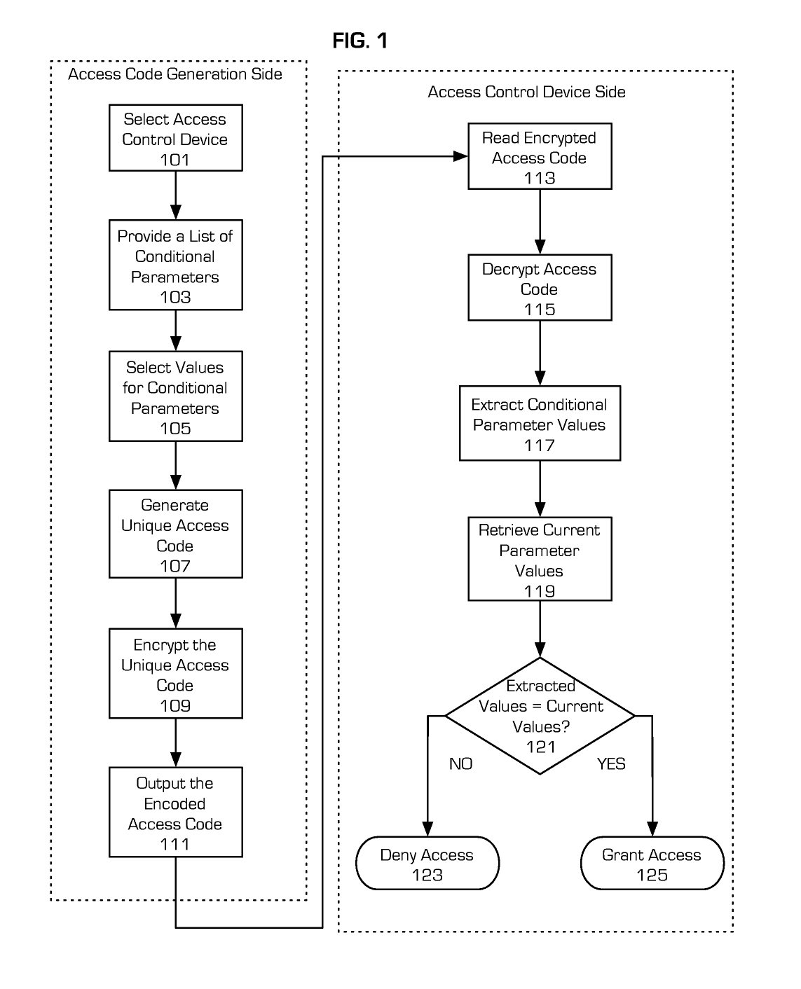

Referring to FIG. 1, a process is shown for generating and using the parametric-based conditional access code of the present invention. Initially the process begins on the access code generation side. A computing device provides a list of available access control devices so that an operator can select an access control device to which to provide access in step 101. A list of conditional parameters supported by the selected access control device is provided in step 103. The operator selects values for one or more of the listed conditional parameters in step 105.

Once the operator is finished setting the values for the conditional parameters, the computing device uses the set values to generate a unique parametric-based conditional access code in step 107. This access code contains representations of the selected parameter values as well as any additional data necessary for the proper functioning of the access control device, such as a serial number or identification number. The unique parametric-based conditional access code is encoded in step 109 and output for the use of the grantee in step 111. As discussed previously, the access code may be provided to the grantee as a pass-code of a predefined number of digits, or embedded in a swipe card as is commonly used in many electronic locks and as credit cards.

Once the grantee has possession of the encrypted access code, the grantee can use the access code to acquire access to a secured area or privilege to which the access code is associated. In step 113 an access control device reads the access code submitted by the grantee. The access control device decodes the access code in step 115 and extracts the conditional parameter values in step 117.

The access control device proceeds to step 119 where current values for the conditional parameters are retrieved. Specifically, the access control device may retrieve the current date and time, location of the access control device such as an address or GPS coordinates, cost or charge in the case of a credit card privilege. Other parameters may be used as well depending on the requirements of the access control device and specific application.

In step 121 the extracted parameter values are compared to the current values retrieved in step 119. If the extracted and current values do not match, then the process continues to step 123 where access is denied. On the other hand, if the extracted and current values match, then the process continues to step 125 where access is granted.

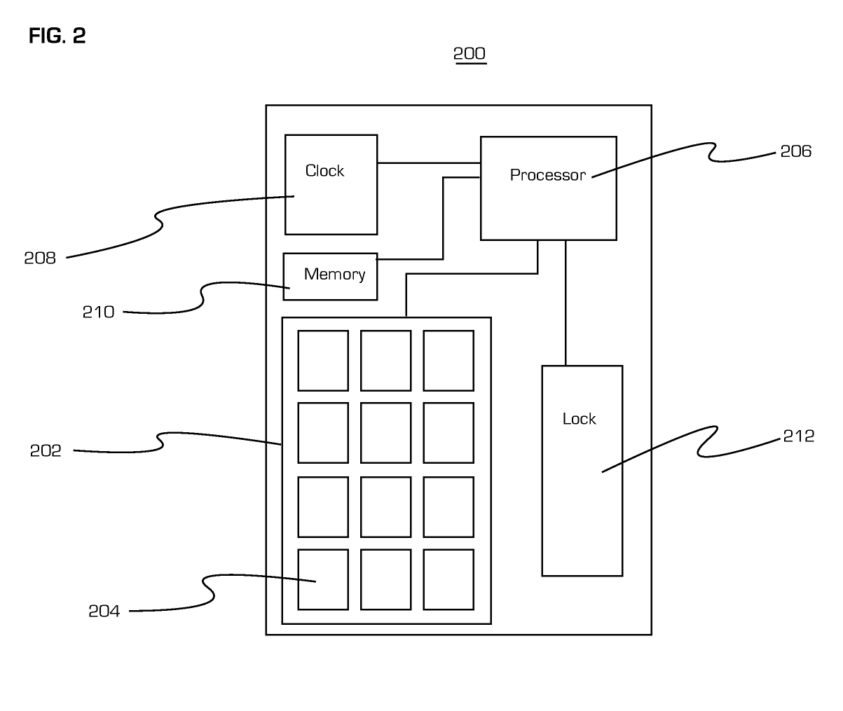

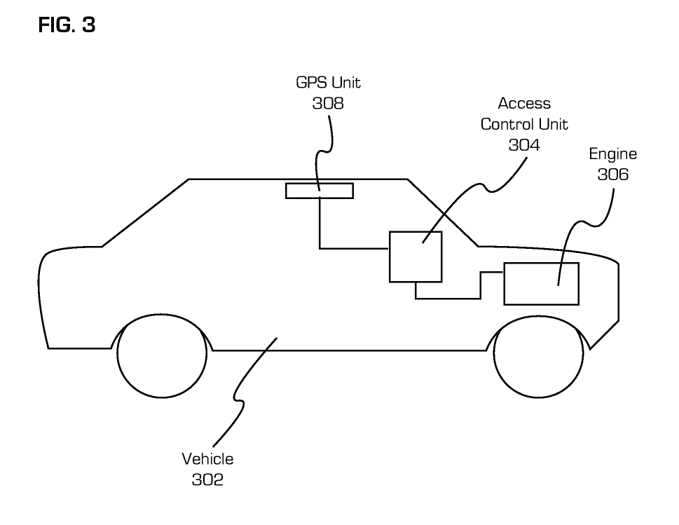

Applications of the present invention are described below with reference to FIGS. 2 and 3. The example applications described hereinafter are intended to demonstrate the range of applications to which the present invention can be directed. However, in no way are the examples intended to limit the present invention to only these applications.

Referring to FIG. 2, by adding a clock 208 to a currently available simple electronic lock 100, a homeowner (grantor) can give limited access to a cleaning person (grantee). The cleaning person is provided with a conditional access code that allows access to the house only during a defined period of time such as Wednesdays between 1 pm and 3 pm for instance. The homeowner would not have to worry about the cleaning person having access to their house at any other time. The homeowner generates the conditional access code using a computing device that would use an encryption formula to calculate the conditional access code based on the following parameters: the electronic lock serial number, or other unique identifier, and the time and day of week the cleaning person would be cleaning their house.

When the cleaning person inputs the conditional code by way of an alphanumeric keypad 202 disposed with a plurality of keys 204, a processor 206 disposed within the electronic lock 200 decrypts the conditional access code and extracts the conditional parameters. The decryption key and other information necessary for determining access are stored in a memory 210 and accessed as needed by the processor.

With the conditional parameters extracted, the processor 206 compares the extracted electronic lock serial number with the serial number stored in memory 210. Additionally, if the extracted serial number and the stored serial number match, the processor 206 retrieves the current date and time from the clock 208. The extracted access time and date are then compared with the current time and date by the processor 206.

With respect to the present invention the term “matching” can mean exact matches between conditional parameter values and current parameter values or that the conditional parameter values fall within a range of current parameter values, depending on the particular parameter and requirements of the access control device.

If based on the comparison the conditional parameters satisfy the current parameters, in this case the current date and time, the processor 206 controls a lock mechanism 212, causing the lock to withdraw and allow access to the grantee, On the other hand, if the current parameter conditions are not met by the conditional parameters, the processor 206 does not release the lock, thus denying access to the grantee.

In the present embodiment the locking mechanism 212 is a physical lock on a door. However in other embodiments of the present invention, such as those discussed below, the locking mechanism 212 can be any apparatus or means for selectively granting or denying access to a secured area or privilege. For example, in the case of a point of sale (POS) device as the access control device, the locking mechanism can be the generation and transmission of a transaction code or charge authorization code to or from a credit card company. In this case, the transaction/authorization code generator and transmitter would constitute the locking mechanism. In a case where the access control device controls access to drive a vehicle, the locking mechanism can be the relays that allow or prevent ignition of the vehicle's engine.

Additionally, in the present embodiment, one conditional parameter generating unit, i.e., clock 208, is shown. However, depending on the particular application of the access control device, other conditional parameter generating devices can be used in combination with or in place of the clock 208. For example, in the POS device a calculating unit may be present to calculate the total charge in addition to the clock. In this way the conditional parameters may be both date and time, and total cost of a purchase.

Moreover, the POS device can be provided with a purchase item description unit that tracks a basic description of the items purchased, for example clothing, entertainment, sporting goods, etc. The item descriptions provide a further conditional parameter, thus allowing a parent to limit a child's purchase of certain categories of goods to a specific amount, or even setting separate spending limits for individual categories. The categories may further include age appropriateness ratings, thus preventing a child from purchasing goods that the parent wishes to restrict based on maturity level. Other conditional parameters not expressly described herein are considered to be encompassed by the present invention as well.

Turning now to a POS device embodiment of the present invention, a credit card holder (grantor) wishes to grant use of a debit or credit card to a third party (grantee) for only a specified period of time at only a specified store for only a specified maximum dollar amount. The grantor generates the conditional access code using a computing device that uses an encryption formula to calculate the conditional access code based on the following parameters: store identifier, the time and date of transaction, and the amount of the transaction.

The conditional access code in this case can be a personal identification number (PIN) that must be entered when the card is used. Alternatively, the conditional access code can be stored on a magnetic strip of a credit card and automatically read by a credit card reader at the time of use. If the conditional access code is stored on the magnetic strip, the computing device must be equipped with a magnetic strip reader/writer so that the computing device can embed the conditional access code on a card.

The POS device, e.g., credit card reader, is equipped with a magnetic card reader for reading the information stored on a magnetic strip of a credit card. If the conditional access code is a PIN, the grantee is required to enter the PIN using a keypad having a plurality of keys. A processor decrypts the PIN and the information stored on the magnetic strip. Additionally, the POS device includes a memory for storing information such as store number, decryption keys, and various other data necessary for processing credit card transactions and decrypting the conditional access code of the present invention. A clock is also disposed in the POS device for providing current time and date to the processor.

Another example is a rental car company restricting the use of their rental car based on certain parameters known by the car at the time of the access request (turning the key to start the car). Currently, the rental car company gives the customer the keys to the car and hopes the customer honors his agreement with the rental car company. However, with the addition of the access control system of the present invention, the rental car company can provide positive control over a customer's compliance with a rental agreement.

Adding a real-time clock to the car would allow the grantor to restrict the use of the car by the customer to a certain period of time of day. For example, if a customer has a DUI conviction on his record, the rental car company could prevent the car from starting between midnight and 6 am, thus reducing the chances of the customer driving the rental car while intoxicated. Also, if a customer does not return the car by the return date, the access code provided to the customer can be set to expire after the return date thus preventing the customer from continuing to drive the car beyond the return date.

Adding a global positioning satellite (GPS) receiver to the car would allow the rental car company to restrict where the car could be started. If the rental car company does not want the customer to take the car outside of a specified area, the rental car company could prevent the car from starting when it was located outside the specified area. All these access restrictions would be conveyed via the conditional access code given to the customer at the time the customer rents the car.

A car-based access control system is shown in FIG. 3. Specifically, the vehicle 302 is equipped with an access control unit 304 connected to the engine 306 of the vehicle 302. When starting the vehicle 302, the driver is required to enter a conditional access code provided by the rental car company. The conditional access code contains codes specifying under what conditions the holder of the conditional access code may operate the vehicle 302. These operating conditions would be in compliance with the rental agreement.

When the conditional access code is provided to the access control unit 304, the access control unit 304 decodes the conditional access code and extracts the relevant parameter codes. These codes for example, may define GPS coordinates within which the vehicle 302 is permitted to operate. The parameter codes are compared against the current parameters of the access control unit 304.

Thus, in the example shown in FIG. 3, the access control unit 304 retrieves the current GPS coordinates of the vehicle 302 from a GPS unit 308. If the current vehicle GPS coordinates are within the area specified by the parameter codes, the access control unit 304 allows ignition of the engine 306. If the GPS coordinates lie outside the specified area, the access control unit 304 prevents ignition of the engine 306.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A method for providing conditional access to secured areas and privileges, said method comprising:
generating a unique access code, by a grantor, based on conditional parameters;
entering said unique access code, by a grantee, into an access control device;
checking said unique access code, by said access control device, against current parameters of said access control device; and
granting access to said grantee, by said access control device, when said unique access code corresponds to said parameters.

2. The method as in claim 1, further comprising denying access, by said access control device, when said unique access code does not correspond to said parameters.

3. The method as in claim 1, wherein said conditional parameters are selected from a group consisting of time and date, duration, location, and cost.

4. The method as in claim 1, wherein said access control device is an electronic lock.

5. The method as in claim 1, wherein said access control device is a point of sale device.

6. The method as in claim 1, wherein said access control device is an automotive ignition device.

7. An access control device comprising:
an input unit for accepting a conditional access code;
a decrypting unit for decrypting said conditional access code;
an extracting unit for extracting at least one conditional parameter for granting access contained within said conditional access code;
at least one parameter maintaining unit for maintaining a parameter of said access control device; and
a processor for comparing said extracted at least one conditional parameter against said maintained parameter of said access control device and determining whether to grant access based on said comparison.

8. The access control device as in claim 7, wherein said at least one parameter maintaining unit is a clock for tracking a time and date.

9. The access control device as in claim 7, wherein said at least one parameter maintaining unit is a memory for storing a unique identifier of said access control device.

10. The access control device as in claim 7, wherein said access control device is an electronic lock.

11. The access control device as in claim 7, wherein said access control device is a point of sale device.

12. The access control device as in claim 12, wherein said at least one parameter maintaining unit is a calculating unit for calculating a cost.

13. The access control device as in claim 7, wherein said access control device is an automotive ignition device.

14. The access control device as in claim 13, wherein said at least one parameter maintaining unit is a GPS unit for providing a location of said access control device.

15. A computer readable medium embodying a set of computer executable instructions for controlling a processor to perform a method of parametric-based conditional access code generation, said method comprising:
providing a list of conditional access parameters associated with parameters of an access control device;
selecting values for each of said conditional access parameters;
generating a unique access code corresponding to said selected values;
encrypting said unique access code; and
outputting said encrypted access code.

16. A computer readable medium embodying a set of computer executable instructions for controlling a processor of an access control device to perform a method of access control based on a parametric-based conditional access code, said method comprising:
receiving a parametric-based conditional access code from a grantee;
decrypting said conditional access code;
extracting conditional parameter values from said decrypted conditional access code;
retrieving current parameter values of said access control device;
comparing said conditional parameter values against said current parameter values; and
determining whether or not to grant access to said grantee based on an outcome of said comparison.
